(19) United States
(12) Patent Application Publication
(10) Pub. No.: US 2026/0346468 A1
(43) Pub. Date: Nov. 5, 2026

(54) SYSTEM FOR CLEANING A STORAGE STRUCTURE COMPRISING CELLS, AND CORRESPONDING ASSEMBLY AND METHOD

(71) Applicant: Ynsect, Évry-Courcouronnes Cedex (FR)

(72) Inventors: Thibault SARTON DU JONCHAY, Chevriéres (FR); Stanislas FAURE, Paris (FR); David MONNIER, Gidy (FR)

(73) Assignee: Ynsect, Évry-Courcouronnes Cedex (FR)

(21) Appl. No.: 19/120,764

(22) PCT Filed: Oct. 12, 2023
(86) PCT No.: PCT/FR2023/051594

§ 371 Date: Apr. 12, 2025

(30) Foreign Application Priority Data
Oct. 13, 2022 (FR) FR2210541

(51) Int. Cl. B25J 11/00; B25J 9/16; B25J 13/08; B25J 19/00

(52) U.S. Cl. CPC B25J 11/0085; B25J 9/1679; B25J 9/1697; B25J 13/089; B25J 19/005

(57) ABSTRACT

A cleaning system suitable for cleaning a storage structure forming storage cells, the cleaning system including a robot (5) with a cleaning device suitable for being transported from one cell to another cell of the structure by a transport system. The robot includes an acquisition device (507) for acquiring information about the three-dimensional configuration of at least one area of its environment. The cleaning system includes a library of pre-recorded cell configurations, each pre-recorded cell configuration being associated with a specific cleaning sequence. The device also includes the ability to compare information about the three-dimensional configuration acquired by the acquisition device with the pre-recorded cell configurations of the library, and a way to determine the pre-recorded cell configuration that is closest to the acquired information about the three-dimensional configuration. The cleaning system is configured such that the robot (5) applies the cleaning sequence corresponding to the determined pre-recorded cell configuration.

### TECHNICAL FIELD OF THE INVENTION

The invention relates to a system for the automated cleaning of certain industrial and storage environments.

The system proposed by the present invention comprises or consists of a robot that aims to clean in particular dry and wet dust, and any other type of residue likely to be deposited in structures suitable for storing goods, and which may be difficult to access.

The invention applies in particular to so-called open structures, such as shelves or “racks” intended for the storage of pallets or other goods carriers. The term pallet broadly refers to any loading platform designed to be handled, in particular using automated means. This includes in particular, in the case of a stack of trays, the tray located at the bottom of the stack when it can be used to maneuver the entire stack. A goods carrier is understood to mean any element suitable for carrying a product or its container and for moving it, in particular pallets.

The storage structures can be “horizontal”, i.e. organized on a single level, or “vertical”, i.e. on several levels, and can form cells suitable for storing products. A cell is understood to broadly refer to a location (whether it is closed, open, or partially open) configured to receive a given goods carrier, and which is defined by the storage structure. In the conventional case of a storage shelf, a cell can thus be defined as the receiving volume between two storage levels and all or part of the width between two vertical uprights of the shelf.

The subject matter of the present invention can be applied in many industrial, agricultural and commercial fields which involve the storage of products. It is of particular interest in the context of the storage of products that may promote the presence of dust or powdery products (for example when storing cereals, or flours, etc.), and/or in the context of storage structures that are not accessible to an operator without wearing numerous or restrictive safety equipment.

For example, the present invention is applicable to so-called “vertical” farms, in which plants or fungi are grown or in which animals are reared in shelving systems, over several levels. The stored products can thus correspond to containers (trays, cages, jars, etc.) and their contents, in particular plants, fungi, or animals grown or reared therein and, where appropriate, their cultivation or breeding environment. The notion of storage, as understood within the present invention, therefore also includes the growth phases of organisms living in this type of farm. One particularly relevant application of the invention relates to insect rearing facilities, for example a facility such as that described in the European patent published under the reference number EP3282837.

### PRIOR ART

Cleaning industrial or storage environments using automated means is envisaged in certain prior art documents.

Document JPH0661814 discloses a cleaning system for pallet racks. In particular, it discloses a sweeping device which, transported by means of a storage/retrieval machine, is suitable for passing between the rack shelves and which comprises sweepers on each side thereof. A vacuum or blower device is also provided to collect or, on the contrary, expel the swept dust or residue.

Document CN212421318 discloses that, for access to complex areas, i.e. in this case the inside of an oil reservoir, the use of a robot equipped with a six-axis arm can be considered.

Document CN109813285 discloses that a floor cleaning robot, i.e. in this case an automatic household vacuum cleaner, can be equipped with means for acquiring an image of an area above the cleaning robot to enable it to be located in its environment. Location information is extracted, and the current position of the cleaning robot is determined in a mapping based on the location information.

Document US20220032347 relates to a cleaning system for semiconductor storage racks. According to this document, a semiconductor storage rack is provided with a plurality of storage spaces. The cleaning system for the semiconductor storage rack comprises a transport system and a cleaning device. The cleaning device is configured to clean each storage space in the semiconductor storage rack. The cleaning device is removably connected to the transport system. The transport system is configured to transport the cleaning device to each cell of the semiconductor storage rack. However, the system of this document, which is specific to semiconductor racks, is unsuitable for many other applications. In particular, the rack's cells have a simple configuration, with no areas likely to retain dust. Above all, the storage environment is generally clean, not disturbed by airborne dust or the presence of insects such as mites.

It should be noted that, for many applications, the creation of a “dust-tight” structure, with closed storage cells, is not conceivable, and would not constitute a solution. For example, in large-scale insect farming, an open design that allows air to circulate is preferred. Moreover, although an open design structure is more exposed to dust than a closed design structure, it is less likely to form dust and residue accumulation areas. Such a structure nevertheless necessarily has such accumulation areas, which are potentially difficult to access. The structures must therefore be manually cleaned periodically.

There is therefore no known system that allows for the automated cleaning of vertical storage structures which can have complex configurations and possibly areas that encourage the accumulation of residues, in the context of an industrial or storage environment which may be disturbed by the presence of airborne dust or flying insects, etc.

### DESCRIPTION OF THE INVENTION

The present invention aims to overcome all or some of the aforementioned drawbacks of the prior art within the context described above.

To this end, the invention relates to a cleaning system, suitable for cleaning a storage structure forming storage cells, the cleaning system comprising a robot suitable for being transported from one cell to another cell of the structure by a transport system, the robot comprising a cleaning device, and an acquisition device for acquiring information about the three-dimensional configuration of at least one area of the robot's environment. The cleaning system comprises a library of pre-recorded cell configurations, each pre-recorded cell configuration being associated with a specific cleaning sequence. The device comprises means for comparing the information about the three-dimensional configuration acquired by said acquisition device with the pre-recorded cell configurations of the library, and means for determining, on the basis of a comparison performed by the comparison means, the pre-recorded cell configuration that is closest to the acquired information about the three-dimensional configuration. The cleaning system is configured such that the robot applies the cleaning sequence corresponding to the determined pre-recorded cell configuration.

By comparing the acquired information about the three-dimensional configuration of the robot environment with configurations of a library, which are in finite or even restricted numbers, in order to determine which cleaning sequence to apply (i.e. the sequence corresponding to the closest pre-recorded cell configuration), it is possible to largely eliminate detection problems in an environment which may be disturbed by airborne dust, the presence of flying insects, spider webs, or even large local differences in brightness, depending on the one or more detection technologies used.

Since there is no need to determine a particular sequence, ad hoc, when cleaning each cell (as would be the case with a robot that adapts its trajectory in real time to detected obstacles), cleaning can be carried out more quickly while using fewer computation means.

The use of a transport system to bring the robot into the different cells of the storage structure to be cleaned allows the transport system that is also used for the facility's production flow to be used here. The movement of the one or more robots can thus become a part of this flow, and cleaning is carried out without the need to stop product movements taking place around a cell being cleaned.

The cleaning device can be configured to perform cleaning by vacuuming, blowing, brushing, washing (applying a cleaning liquid such as water), or by combining several of these cleaning modes.

The robot can comprise a computer memory in which the library is stored. Alternatively or in addition, the cleaning system can comprise a computer system that is remote from the robot, and the robot can comprise communication means suitable for communicating with the computer system, the computer system comprising the library and/or being configured to order the cells of the storage structure to be cleaned. In other words, the means allowing the selection of the cleaning sequence to be applied for a given cell are either decentralized at robot level, offering it a large operational autonomy, or centralized within a remote computer system which can also manage all or part of the production of the facility (farm or plant, etc.) that comprises the cleaning system.

The acquisition device can comprise a three-dimensional camera, preferably of the “time of flight” type. Other means of acquisition can be considered, comprising for example a stereoscopic camera or a three-dimensional scanner.

The cleaning device of the robot can comprise a poly-articulated arm, for example a six-axis arm. The poly-articulated arm, for example the six-axis arm, can comprise a curved nozzle at its end. A nozzle is a conduit that allows air to pass therethrough, and in this case preferably forms a vacuum tip of a central vacuum unit. The curved shape makes it easier for the tip of the curved nozzle to reach corners. A poly-articulated arm refers to a mechanical arm comprising several articulations, which give it several degrees of freedom. A maximum number of areas to be cleaned can be reached thanks to the combination of a poly-articulated arm and a curved nozzle. Further details on the development of the curved nozzle are given below. Other possible solutions exist to carry out cleaning. For example, alternatively or in addition to the poly-articulated arm, cleaning car take place using a fluid spraying device. The fluid can be air, water, or a liquid (aqueous or non-aqueous) disinfectant. The spraying device can comprise fluid diffusion nozzles.

According to various possible embodiments:
the cleaning system can be configured so that the robot is inactive as long as it is carried by the transport system;
the robot can comprise a battery supplying the robot with electricity.

In particular, the battery supplies the cleaning device comprised in the robot, and its electronic control systems. If the robot comprises a battery, it can be recharged periodically (at regular intervals or when it is determined that charging is desirable) at a charging station, and if necessary, a maintenance station, provided in the storage area or next to the storage area. Alternatively or in addition to periodic charging at a charging station, power can be supplied to partially charge the battery while the robot is in the storage structure. For this purpose, one or more cells of the structure can be equipped to allow this power to be supplied to the robot. Such frequent and partial charging of the robot battery can be referred to as “opportunity charging” of the robot.

The invention further relates to an assembly comprising a cleaning system as defined above, a storage structure forming storage cells, and a transport system. The storage structure can be a set of shelves, for example a pallet rack, or any type of analogous storage structure defining cells for receiving products, for example palletized products.

The transport system can be a storage/retrieval machine.

The invention further relates to a storage area comprising an assembly as defined above. The invention further relates to a farm (for example a vertical farm) for cultivation or rearing and comprising such a storage area. This farm can be an insect farm.

Such a vertical farm can in particular be an insect farm.

Finally, the invention relates to a method for cleaning a storage structure forming storage cells comprising the steps of:
a) supplying an assembly as defined above;
b) transporting the cleaning robot to a storage cell;
c) acquiring, by the robot, information about the three-dimensional configuration of at least one area of its environment;
d) comparing acquired information about the three-dimensional configuration with pre-recorded cell configurations of a library;
e) determining, based on the comparison step, the pre-recorded cell configuration that is closest to the acquired information about the three-dimensional configuration;
f) applying, by the robot, a cleaning sequence corresponding to the determined pre-recorded cell configuration.
   This method can further comprise determining a subsequent cell to be cleaned and repeating steps b) to f) for this cell. It is thus possible to clean all the cells of the structure successively, and/or to perform continuous cleaning of this structure, without stopping production in order to perform the cleaning operations.

### BRIEF DESCRIPTION OF THE FIGURES

Other advantages, aims and particular features of the present invention will appear from the following non-limiting description of at least one particular embodiment of the devices and methods that are objects of the present invention, with reference to the appended drawings, wherein:

FIG. 1 is a diagrammatic three-dimensional view of a facility comprising a storage structure, and wherein the invention can be implemented;

FIG. 2 is a diagrammatic three-dimensional view of a storage structure that can be cleaned by a system according to the invention;

FIG. 3 is a three-dimensional diagrammatic view of a robot that can be part of a cleaning system according to an embodiment of the invention or constitute such a cleaning system;

FIG. 4 shows the robot of FIG. 3 placed in a storage cell to be cleaned;

FIG. 5 shows a point cloud in space that can be acquired by an acquisition device of a robot implemented in one embodiment of the invention;

FIG. 6 shows the point cloud of FIG. 5 after post-processing;

FIG. 7 shows a portion of the point cloud of FIG. 6, after a second post-processing operation.

### DETAILED DESCRIPTION OF THE INVENTION

The present description is given as a non-limiting example embodiment.

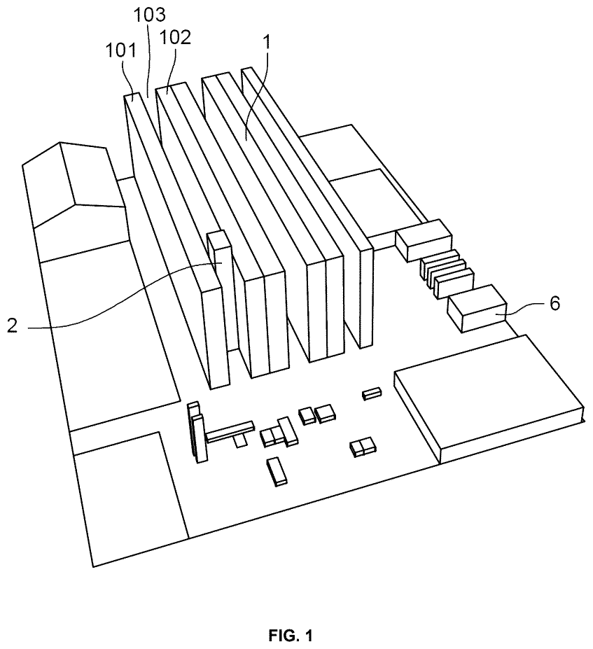

FIG. 1 shows a facility, i.e. a vertical farm, in this case represented in the form of a diagrammatic view in three dimensions.

The vertical farm shown can in particular be an insect rearing farm. Insects that can be reared on such a farm include Coleoptera, Diptera, Lepidoptera, Neuroptera, Isoptera, Orthoptera, Hymenoptera, Blattodea, Hemiptera, Heteroptera, Ephemeroptera and Mecoptera.

Insect rearing can in particular be considered as an organized unit that allows adult insects to lay eggs for the production of larvae, with some larvae being raised to the adult stage for laying new eggs and adults being regularly renewed (for example following their death) by young adults providing new layings and so on. The end product of the production can be eggs, and/or larvae, and/or nymphs, and/or adult insects. The term “insect” therefore refers to any stage of development from egg to adult.

In addition to the technical equipment and/or the equipment for carrying out certain production operations, the facility in FIG. 1 comprises a storage structure 1. This is a so-called vertical storage structure, over several levels, which allows so-called vertical storage of products. Such products can, in the case of a vertical farm, be plants or animals produced by the farm, for example insects in a growth phase.

For example, in an insect rearing facility, insects grow in suitable containers placed in the storage structure, under controlled and optimized environmental conditions (defined by environmental parameters including temperature, hygrometry, etc.).

The storage structure can in particular comprise pallet shelving units 101, 102 (typically referred to as “pallet racks”) or similar shelving structures.

In the example shown in FIG. 1, the pallet shelving units 101, 102 are separated by an aisle 103 allowing traffic between the shelving. A plurality of parallel sets of shelving units/aisles/shelving units can be present in the facility.

The aisle 103, and more generally the aisles that are formed between the pallet-shelving units, allow for the movement of a transport system 2, for example of a storage/retrieval machine used to move the products to be placed in the shelving units or extracted therefrom.

Products or containers receiving the products can be stacked on pallets, for example standardized pallets (for example “Euro-pallets” measuring 120 cm in length by 80 cm in width, or half-pallets of this type measuring 80 cm in length by 60 cm in width), or can be stacked on any element forming a suitable carrier.

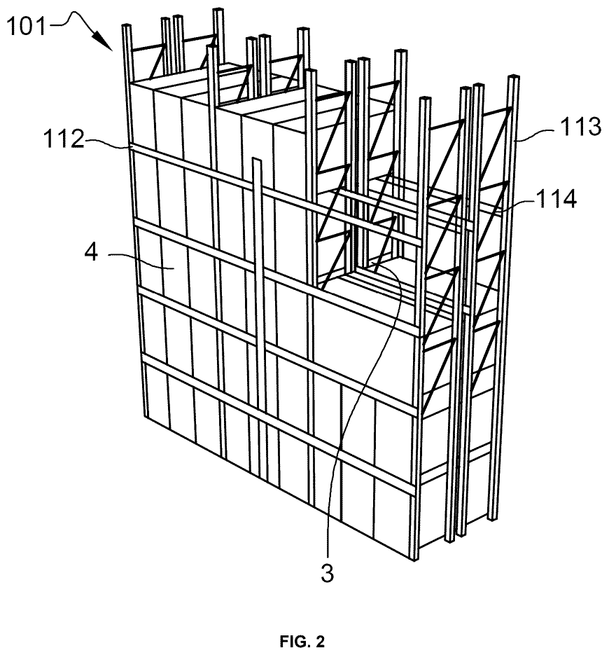

One example of a storage structure in which a cleaning system according to the present invention can be used is shown in FIG. 2. The structure 101 is a pallet-shelving unit. It comprises a so-called “open” structure. It therefore comprises a framework 111 comprising a set of horizontal beams 112, vertical beams 113 and reinforcement beams 114, and it is devoid of partitions which would create closed volumes.

Depending on the facility's environment and the products present in the storage structure 1, this structure is liable to accumulate dust and residues. Dust and residues come from the facility's environment, the outside atmosphere, the operation of machines, or people who may be moving around in the facility, etc. In the context of farming insects, or other animals, they can come from the activity of the animals or their rearing environment, etc. They also include residues related to parasitic insects and spiders present in the farm, such as their feces, webs, and cadavers.

For example, the beams can have dust and debris that settle on them.

Storage cells 3 are formed between the beams of the storage structure 1.

Products 4 can be stored in each cell 3. Preferably, the cells 3 therefore have a certain dimensional uniformity and more typically a uniform general shape.

However, the cells are typically not formed strictly identical to one another. The position of the beams varies depending on whether or not the cell is at the end of the shelving unit, depending on the level at which it is located, depending on whether it is a left or right aisle (according to a conventional orientation of the aisles), etc.

A finite number of different cell configurations is thus present in a storage structure. However, each cell configuration potentially presents different dust accumulation areas. The areas to be cleaned are therefore different depending on the configuration of the cell considered, and the obstacles that can prevent this cleaning and/or limit the movements of a cleaning robot are different.

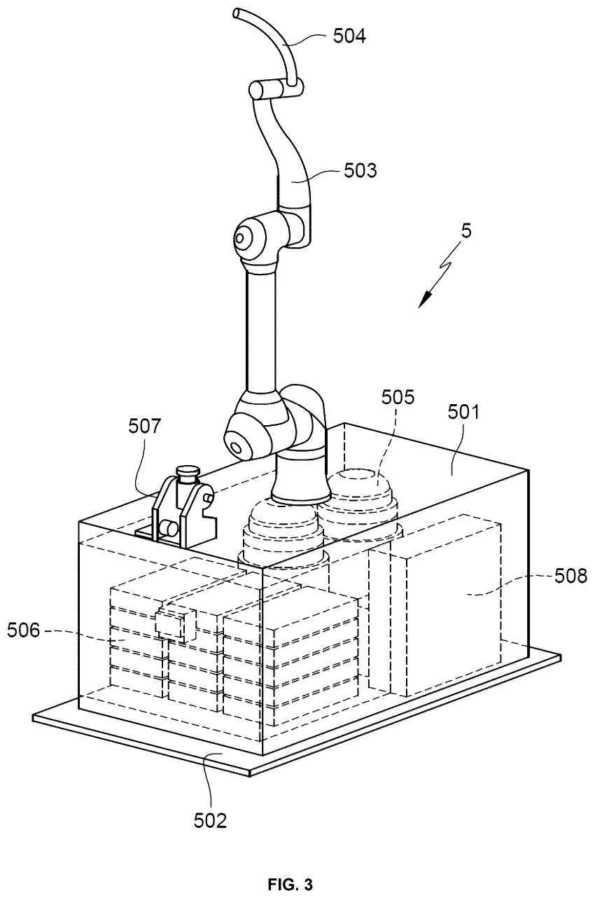

FIG. 3 shows a diagrammatic three-dimensional view of a robot 5 which can be part of a cleaning system according to the present invention or which can constitute it. The robot 5 is intended to clean the cells in which it is successively placed, and comprises a cleaning device suitable for this.

The robot 5 comprises a housing 501 represented transparently in FIG. 3 in order to allow a certain number of elements internal to the robot 5 to be visualized.

The robot 5 is intended to be transported using the transport system 2 used to place the products in the storage cells and remove them therefrom. For this purpose, the robot 5 comprises, for example, a base 502 compatible with the transport thereof by the transport system 2, for example a base 502 suitable to be carried by a storage/retrieval machine.

Since the robot is preferably transported by the same transport system as that for the stored products, the robot can be integrated into the product flow, according to a precise cleaning plan. Thus, for example, production does not need to be stopped in one area of the facility in order to clean the cells of this area, since this cleaning is carried out when the products, which are, for example, palletized, are extracted from a given cell. Cleaning is carried out at the same time as production, for example during production hours.

Integrating the robot into the production flow, according to the cleaning plan, also leads to the scheduling of operations for charging the robot's battery pack (see below), unloading collected dust and residues, and even maintenance operations. These operations can be planned in advance, or initiated as needed (for example, when a robot tank is full of dust), thereby modifying the current cleaning plan.

These operations can be carried out in one or more dedicated stations of the facility.

Of course, in a facility comprising a large storage structure, several robots 5 can operate at the same time. The facility's production management system then takes into account the use of multiple robots to adapt the cleaning plan for each robot.

Moreover, it is important to ensure that the robot is inactive, i.e. that it does not start moving (for example its arm or another moving part of the robot does not start moving), when it is being transported by the transport system between two cells, or from a cell to a charging and/or maintenance station, or from a station to a cell, etc. Indeed, it must be ensured that robot movements do not disrupt the transport system, and for example that the deployment of a moving part of the robot could not interfere with the structures present in the facility.

Similarly, it is best to ensure that the robot remains idle when it is in a charging and/or maintenance station.

Various means can be used for this.

Firstly, a physical means can be provided, allowing the robot 5 to be deactivated when it is carried by the transport system 2 or present in a charging and/or maintenance station. This means may, for example, be a switch configured to be actuated when the robot 5 is on the transport system 2 or in the station. Conversely, it can be a switch configured to be actuated when the robot is correctly positioned in a storage cell.

Furthermore, communication can be established between the robot 5 on the one hand and the transport means 2 and/or a computer system 6 on the other hand. The purpose of this communication is to confirm to the robot, via an activation command, that it can activate itself.

The computer system 6 can be (or be interfaced with) the system that manages the production of the facility, and in particular the flows of products in the storage structure and in the facility. The computer system 6 thus makes it possible in particular to plan the charging of the battery pack of the robot 5, or to manage the movements of the robot in the storage structure, by the transport means 2, in order to clean the cells in a predefined order, according to a cleaning plan. The computer system, knowing the position of the robot 5 in the facility, can transmit an activation command thereto when the robot is in position in a cell. This can also be accomplished via the transport system 2, which itself is in communication with the computer system 6.

In the facility, communications between the robot 5, the computer system 6, the transport system 2, and potentially other devices present in the facility can be realized using various wireless communication protocols, including WiFi, Bluetooth, Bluetooth Low Energy, Sigfox, Zigbee, or any other suitable protocol, including long-range and low-speed protocols and/or any protocol associated with the Internet of Things.

Finally, the robot movements can be inactivated as long as the robot has not determined that it is in position in a cell whose three-dimensional configuration has been determined according to the methods explained below.

In the example shown, the cleaning device of the robot 5 comprises an articulated arm 503 that allows the areas to be cleaned in each of the cells of the structure to be reached. The arm 503 can in particular be a “six-axis” arm. A six-axis arm is a system commonly used in the industry for performing operations that require complex and/or combined movements.

In order to reach all or almost all areas where dust and residues can accumulate in a cell of a given configuration, the arm 503 is equipped at its end with a curved nozzle 504. The curved nozzle 504 is hollow and allows dust and residues to be vacuumed.

The shape of the curved nozzle is subject to significant development and can vary depending on the storage structure in which the cleaning system according to the invention is used.

The development principle for the curved nozzle 504 is as follows. The different three-dimensional configurations of the cells present in the storage structure are modeled. The areas to be cleaned are determined for each configuration. The robot and its arm (or other mechanism) are modeled. The shape of the curved nozzle 504 is determined so as to maximize the areas to be cleaned that can be reached by the end of the curved nozzle 504. This involves maximizing the surface area of the area to be cleaned that will actually be cleaned, with the aim of ensuring that all surfaces to be cleaned are cleaned.

This maximization can be performed for each cell configuration or for the entire structure. For example, if some cell configurations are less present in number than other configurations in the storage structure, it is possible to weight the importance of the various configurations. In other words, it is possible to favor the complete or near-complete cleaning of the cells having the most common configurations to the detriment of the cleaned surface area of the cells whose configuration is less common, for example to maximize the total cleaned surface over the entire storage structure.

In the example shown here, the robot is configured to clean by simple vacuuming. According to other arrangements of the invention, the end of the arm 503, i.e. the end of the curved nozzle 504 if the robot comprises such a nozzle, can be equipped with a brush. This brush can be stationary, with the arm allowing the brush to sweep. Alternatively, this brush can be motorized. It can, for example, be a rotating brush, which can advantageously be actuated in both directions of rotation, to ensure back and forth brushing of an area to be cleaned.

The robot 5 comprises one or more central vacuum units 505. The one or more central vacuum units are connected to the curved nozzle 504 via whose end vacuuming is performed. The fluid connection between the one or more central suction units and the curved nozzle can be made inside or outside the arm 503, for example using a flexible hose. In the example shown, two central vacuum units 505 are present. Central vacuum systems can consist of conventional industrial vacuum cleaners. According to various embodiments, the central vacuum units 505 can be used simultaneously, for example to increase the vacuum at the outlet of the curved nozzle 504, or one after the other (for example as soon as a dust tank of a central vacuum unit is full, another is used).

The robot is advantageously powered by a pack of batteries 506. Different battery technologies, in particular different battery chemistries, can be used. In the context of the present invention, the robot being for industrial use and transported by a transport system that is independent of the robot, a reliable battery technology will typically be preferred, i.e. a technology posing few safety issues (overheating, etc.), and having a long service life, compared to technologies that can have better specific energy but are less reliable, and/or likely to present safety risks in the event of a fall, with the robot being used in a vertical storage structure.

For example, a pack of lead-acid batteries can be used.

The robot 5 comprises an acquisition device 507. The acquisition device is a device for capturing and acquiring information about the three-dimensional configuration of at least one area of the environment of the robot 5. Information about the three-dimensional configuration is understood to mean information that makes it possible to reconstitute the three-dimensional shape of a part of the environment of the robot 5. This can be a point cloud corresponding to a raw or post-processed signal. The robot's environment is understood to mean the elements surrounding the robot that are in the line of sight of the acquisition device. This can be referred to as the “immediate” environment of the robot.

The acquisition device can thus advantageously comprise a three-dimensional camera, for example of the “time of flight” type (also designated by the acronym “TOF”). Time-of-flight technology, based on the reflection time of radiation (typically infrared), associates each pixel in the sensor's field of view with a distance to the sensor. An “image” of distances, or field of depths, is thus obtained, and corresponds to the three-dimensional representation of the elements visible in a direct line from the sensor.

Other information acquisition technology, for example stereophotography, or three-dimensional scanning technology, can be used.

The acquisition device can be stationary or movably mounted. In the example shown, the acquisition device 507 is mounted rotatably in two directions. This allows a larger area of the sensor's environment to be scanned, thus reconstructing the three-dimensional configuration of a relatively large part of the robot's immediate environment.

It is also possible to acquire the information, using the acquisition device 507, when placing the robot 5 in a storage cell 3. The movement of the robot imposed by the transport system 2 thus allows the cell to be scanned to a certain extent by the detection field of the acquisition device. The acquisition device then allows the robot to acquire information representative of the three-dimensional configuration of the cell or of a part thereof.

The information acquired via the acquisition device can be stored directly in the robot 5 or transmitted and stored in the computer system 6 for subsequent processing (for example to optimize cleaning sequences, or monitor the proper execution thereof).

The robot further comprises a control device 508. The control device 508 groups together the various control and communication functions of the robot 5. These functions could alternatively be provided by a plurality of separate modules.

The control device 508 thus comprises the means for controlling the arm 503 so that it performs the movements necessary for the application of an appropriate cleaning sequence for the cell 3 in which the robot is present. The cleaning sequence thus comprises the movements of the arm 503, as well as, where applicable, instructions for actuating the vacuuming, the brushes, and instructions for changing the tool of the robot, etc.

The control device 508 further comprises the means for controlling the acquisition device. The means for controlling the acquisition device make it possible to control the acquisition of information about the three-dimensional configuration in the environment of the robot 5. This involves triggering this acquisition, typically once the robot is in position in a cell to be cleaned, and, where necessary, controlling the movements of the acquisition device (for example the movements of the sensor or of the three-dimensional camera).

The control device 508 also makes it possible to collect a certain amount of information on the status of the robot. This information on the status of the robot 5 can comprise the charge level of the battery pack 506, the fill level of the one or more central vacuum tanks 505, the occurrence of certain faults, etc. This information can also comprise information about the position of the robot in the storage structure, which can be acquired by the robot 5 or obtained from the transport system 2 or a management system of the facility.

The control device 508 can further comprise communication means. The communication means of the robot are suitable for communicating with the computer system 6 that is remote from said robot 5.

According to the invention, when the robot 5 is placed in a storage cell, the cleaning sequence to be applied is determined by comparing the information about the three-dimensional configuration of at least one area of the robot's environment with pre-recorded cell configurations present in a library.

The pre-recorded cell configuration with the best match is determined. This determination is carried out according to conventional comparison or shape recognition algorithms, aimed for example at minimizing the deviations between measured (acquired) points and corresponding points of the pre-recorded cell configurations.

A pre-recorded cell configuration is understood to mean the three-dimensional configuration of the whole or only a part of a cell, said part being distinct from the other pre-recorded configurations.

This comparison can be made by the control device 508. The control device can comprise the library of pre-recorded cell configurations, i.e. it can comprise the computer memory in which the library is recorded. This library can then be updated, if necessary, during maintenance operations on robot 5.

Alternatively, the library of pre-recorded cell configurations can be comprised in the computer system 6, i.e. be recorded in a computer memory that is comprised in the computer system 6. In this case, the configurations can be transmitted to the robot via its communication means, and the control device 508 of the robot performs the comparison. Otherwise, the robot can transmit, via its communication means, the acquired information about the three-dimensional configuration of at least one area of its environment to the remote computer system 6 that will perform the comparison.

Thus, the comparison means implemented in the invention can be included in the control device 508 of the robot 5 or be in the computer system 6.

FIG. 4 shows the robot 5 positioned in an example of a storage cell 3 to be cleaned. Since the volume located between two vertical beams 113 is suitable for receiving two pallets side by side, it is considered here that a cell corresponds to half of this volume, i.e. it corresponds to the volume for receiving a pallet and the products it carries.

The beams 112, 113, 114 forming the cell 3 and to be cleaned by the robot 5 are marked with points in FIG. 4.

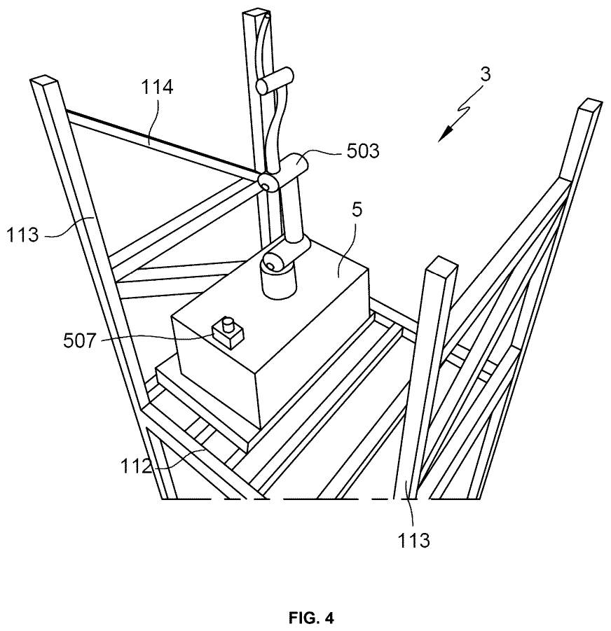

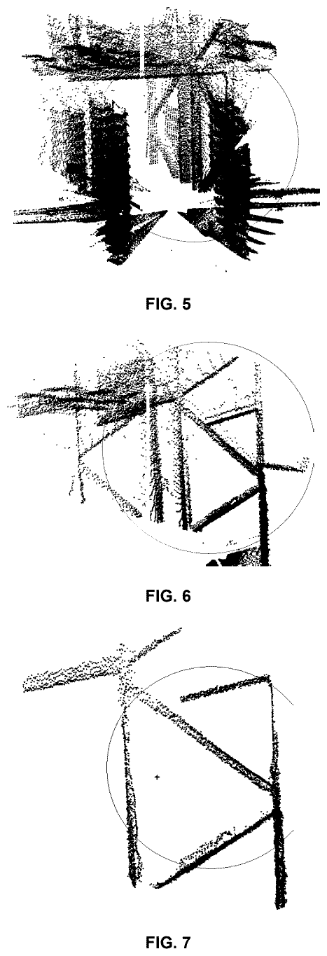

FIG. 5 shows an example of a point cloud, in space, that can be obtained by the acquisition device 507 (which in the example shown comprises a “time of flight” camera).

As can be seen, this raw point cloud comprises a lot of noise resulting in points that are not significant. This is due to various factors, but significant noise is especially present when the environment of the robot and sensor comprises airborne particles, flying insects, or spider webs, etc.

This raw point cloud is then post-processed, allowing a three-dimensional shape evoking the position of the beams that are around the robot to be extracted, as shown in FIG. 6. A more advanced post-processing operation allows a set of points to be extracted, for visualizing the general configuration of the beams, and more generally of a part of the environment of the robot 5, as shown in FIG. 7.

FIG. 5 to 7 illustrate, among other aspects, why it is advantageous in the context of the present invention to compare the acquired information with pre-recorded cell configurations.

It is thus noteworthy that, within the scope of the present invention, the cleaning sequence that is applied to a given cell is not determined in real time directly and for each cell based on the configuration information acquired by the acquisition device 507. On the contrary, the cleaning sequence applied is a sequence predefined for the pre-recorded cell configuration that is determined after the comparison.

Indeed, on the one hand, only part of the cell to be cleaned is “scanned” by the robot 5. Optionally, it would be possible to configure the robot so that the acquisition device can scan the entire area to be cleaned, but in this case the acquisition device would be very complex. On the other hand, and above all, as illustrated in FIG. 5 to 7, the acquisition device only allows a very approximate representation of the three-dimensional configuration of the cell to be obtained. The sensor is disrupted by a certain number of elements in the detection field (dust, residues, insects, etc.). Moreover, certain surfaces to be cleaned may simply not be perceived by the sensor (the sensor of the acquisition device may, for example, acquire information about the three-dimensional shape of the underside of a beam located above it, whereas it is the upper surface of this beam, which is invisible to the sensor, that must be cleaned).

It turns out that even in a relatively complex industrial environment such as a vertical farm, the number of different cell configurations is finite and relatively limited. By way of example, the Applicant has determined that in an example of a vertical farm for rearing insects, comprising shelving units of the pallet rack type defining several aisles therebetween for the passage of storage/retrieval machines, the shelving units allowing stacks of containers to be stored over two levels of depth, the storage structure comprises about twenty three-dimensional cell configurations.

The cleaning system developed within the framework of the present invention, comprising a robot or consisting of a robot transported in the cells of a storage structure, allows such a storage structure to be cleaned while overcoming the problems involving the detection of the environment of the robot. In particular, comparing information acquired by the robot about its environment with configurations pre-recorded in a library makes it possible to apply the correct cleaning sequence for a given cell, even if the robot's acquisition means are disrupted by airborne dust or flying insects, etc.

Cleaning can also be carried out in parallel with production, by integrating the robot into the logistics flows provided by a transport system of the facility.

1. Cleaning system suitable for cleaning a storage structure (1) forming storage cells, the cleaning system comprising a robot (5) suitable for being transported from one cell (3) to another cell (3) of the structure by a transport system (2),
the robot (5) comprising a cleaning device,
and an acquisition device (507) for acquiring information about the three-dimensional configuration of at least one area of the environment of the robot (5),
characterized in that the cleaning system comprises a library of pre-recorded cell configurations, each pre-recorded cell configuration being associated with a specific cleaning sequence,
and in that the device comprises means for comparing the information about the three-dimensional configuration acquired by said acquisition device with the pre-recorded cell configurations of the library,
as well as means for determining, based on a comparison performed by the comparison means, the pre-recorded cell configuration that is closest to the acquired information about the three-dimensional configuration,
the cleaning system being configured such that the robot (5) applies the cleaning sequence corresponding to the determined pre-recorded cell configuration.

2. Cleaning system according to claim 1, wherein the robot comprises a computer memory in which the library is recorded.

3. Cleaning system according to claim 1, comprising a computer system that is remote from the robot, and wherein the robot comprises communication means suitable for communicating with the computer system, the computer system comprising the library and/or being configured to order the cells of the storage structure to be cleaned.

4. Cleaning system according to claim 1, wherein the acquisition device comprises a three-dimensional camera.

5. Cleaning system according to claim 1, wherein the cleaning device of the robot comprises a poly-articulated arm.

6. Cleaning system according to claim 5, wherein the poly-articulated arm comprises a curved nozzle at its end.

7. Cleaning system according to claim 1, preceding claims, configured such that the robot is inactive as long as it is carried by the transport system.

8. Cleaning system according to claim 1, wherein the robot comprises a battery supplying the robot with electricity.

9. Assembly comprising a cleaning system according to claim 1, storage structure forming storage cells, and a transport system.

10. Assembly according to claim 9, wherein the storage structure is a set of shelves.

11. Assembly according to claim 9, wherein the transport system is a storage/retrieval machine.

12. Storage area comprising an assembly according to claim 9.

13. Farm for cultivation or rearing, comprising a storage area according to claim 12.

14. Method for cleaning a storage structure forming storage cells comprising the steps of:
a) supplying an assembly according to claim 9;
b) transporting the cleaning robot to a storage cell;
c) acquiring, by the robot, information about the three-dimensional configuration of at least one area of its environment;
d) comparing acquired information about the three-dimensional configuration with pre-recorded cell configurations of a library;
e) determining, based on the comparison step, the pre-recorded cell configuration that is closest to the acquired information about the three-dimensional configuration;
f) applying, by the robot, a cleaning sequence corresponding to the determined pre-recorded cell configuration.

15. Method according to claim 14, further comprising determining a subsequent cell to be cleaned and repeating steps b) to f) for this cell.

16. Cleaning system according to claim 1, wherein the acquisition device comprises a “time of flight” type three-dimensional camera.

17. Cleaning system according to claim 1, wherein the cleaning device of the robot comprises a six-axis arm.

18. Farm for rearing insects, comprising a storage area according to claim 12.
